(19) United States
(12) Patent Application Publication
(10) Pub. No.: US 2024/0166908 A1
(43) Pub. Date: May 23, 2024

(54) DIGITAL INKJET PRINTING PRIMER FOR PLASTIC FILMS FOR FOOD PACKAGING

(71) Applicant: GOGLIO S.P.A., Milano (MI) (IT)

(72) Inventors: Osvaldo Bosetti, Milano (MI) (IT); Mauro Fedeli, Milano (MI) (IT); Fabio Rimoldi, Milano (MI) (IT)

(73) Assignee: GOGLIO S.P.A., Milano (MI) (IT)

(21) Appl. No.: 18/552,694

(22) PCT Filed: Mar. 29, 2021
(86) PCT No.: PCT/IT2021/000014

§ 371 Date: Sep. 27, 2023

(51) Int. Cl. C09D 11/54; B41M 5/00; C08J 7/04; C09D 11/033; C09D 11/037; C09D 11/104; C09D 11/107; C09D 11/108; C09D 11/322; C09D 11/36; C09D 11/38

(52) U.S. Cl. CPC C09D 11/54; B41M 5/0017; B41M 5/0047; B41M 5/0064; C08J 7/042; C09D 11/033; C09D 11/037; C09D 11/104; C09D 11/107; C09D 11/108; C09D 11/322; C09D 11/36; C09D 11/38; C08J 2323/12; C08J 2367/02; C08J 2423/02; C08J 2433/04; C08J 2467/00; C08J 2475/04

(57) ABSTRACT

Primer composition for digital inkjet printing on plastic polymer films possibly laminated with: one or more plastic films of the same or different polymer and/or aluminium and/or paper comprising: a) at least one resin having affinity with said plastic polymers; b) at least one aliphatic or aromatic C2-CI 0 organic mono-, bi- or tricarboxylic acid, possibly being replaced in the aliphatic chain or aromatic ring with one or more halogen atoms and having pKA between 0.2 and 5; c) an organic solvent selected from at least one ether, at least one ester, at least one aliphatic alcohol, at least one ketone, at least one C6-C 10 alkane, or from those belonging to the positive list defined by Swiss Ordinance 817.023.21 Annex 10 and/or mixtures thereof, said organic solvent having a boiling point between 35 and 250° C.

### FIELD OF THE INVENTION

The present invention relates to a composition for use as a primer for digital inkjet printing.

### BACKGROUND ART

Digital printing is gaining increasing interest related to the possibility it offers to drastically reduce all the expenses and downtimes associated with:
setting and preparing a rotogravure or flexographic machine for the production of a new printing subject.
Costs for printing cylinders or plates

Multiple technologies exist which can be enclosed in the digital printing concept, and among these the most widespread are:
thermal transfer technology
laser technology, of which INDIGO is a reinterpretation
inkjet technology

Our attention has focused in particular on inkjet printing, where technological innovation has made it possible to put increasingly efficient printheads on the market which ensure ever higher production speeds. It is with this process that hourly productivity is reached which is more similar to a rotogravure printer and it is this technology which could potentially compete with the same rotogravure.

In fact, it is calculated that the next generation printheads are capable of working beyond the 40 khz frequency, allowing to support printing speeds greater than 90 m/min; this allows to move the breakeven point, of the competitiveness of inkjet printing with respect to rotogravure printing, to over 15000 linear meters.

Inkjet printing technology is divided according to the chemical nature of the ink into subgroups such as:
Cross-linked E-BEAMs
Cross-linked UV/UV-LEDs
Solvent-based
Water-based

All these inks must meet some typical chemical-physical parameters of the printheads which are used. In general, the parameters which must be respected are:
Particle sizes: a D99 of less than 0.5 μm is generally requested. The request is related to the size of the nozzle, from which the drop is fired, which is generally about 10 μm in size. It follows that overly large particle sizes can cause an irreversible nozzle blockage problem with damage to the printheads;
Viscosity: the working viscosity of the printhead can be varied depending on the mechanical features thereof. In general a printhead has a maximum working range of 1-2 cP. Printheads can be found on the market which work at 5 cP, as well as heads which work at over 20 cP;
Surface tension: as in the case of viscosity, this parameter also varies depending on the printhead used. The reference values are around 30 mN/m

Water-based digital printing technology is similar and suitable for productions which must comply with the regulations governing packaging intended for food contact.

The logic behind inkjet printing is the creation and/or definition of a printing layout by depositing droplets of ink, sized in the order of picolitres, on the printing substrate. It is important that the droplets which reach the substrate “bind” thereto, preventing the movement thereof from leading to a loss of image resolution: this phenomenon can occur by absorption of the substrate in the case of films such as paper (absorbent substrates), while in the case of plastic films, with no absorption capacity, it is necessary to make the plastic film receptive to the ink through the application of a primer.

From a chemical point of view, the primer contains cationically charged reactive groups. These interact with the inks, of anionic nature, leading to ionic type chemical interactions (or the like). The final effect is called “coagulation” and has the macroscopic effect of blocking the drop on the surface of the substrate, avoiding the movement thereof (loss of definition) or interaction/mixing with neighbouring drops (loss of definition causes the “bleeding” effect).

From a chemical perspective, the ionic interaction between ink and primer leads to an increase in ink drop viscosity, forming a contact angle between drop and surface at around 35°.

The primer thus ensures the definition of the printed image.

In addition to this function, the primer must also ensure the adhesion of the ink to the substrate, allowing the suitability of the downstream machining processes.

In the case of flexible packaging, this results in
thermal resistance at the sealing bars
delamination resistance after matching the printed film against the plastic film, aluminium film or paper.

In this perspective, different solutions have been evaluated with different chemistries.
Aqueous vinyl acetate dispersions
Aqueous polyurethane dispersions with the addition of inorganic salts
Acrylic aqueous dispersions with the addition of inorganic salts
Polyurethane-polycarbonate aqueous dispersions
Polyurethane-polycarbonate aqueous dispersions with the addition of organic salts.

Chlorides of some alkali earth metals such as Magnesium and Calcium, or chlorides of other metals such as aluminium have been used as inorganic salts.

As will be noted in the experimental part of the present description, the results obtained with this type of primer did not allow to obtain the desired results.

In fact, the water-based primers showed poor resistance to moisture and decidedly low adhesions due to detachment of the primer from the printed substrate.

The causes of this poor resistance are due to the chemical nature of the reactive cationic compounds, whether they are identifiable as inorganic salts or cationic appendages bound to the polymer resin.

These salts have a strong tendency to absorb moisture. By way of example, calcium chloride can be presented mainly as dihydrate or hexahydrate and is used as a drying agent. Under ambient conditions, calcium chloride absorbs moisture from the air and tends to dissolve, forming a solution until a balance is reached between the vapour pressure of the aqueous solution and the partial pressure of the water present in the air.

Anhydrous calcium chloride gives rise to an exothermic reaction when it absorbs water. Without wishing to be bound by any theory, it is believed that the absorption of water creates a partial redissolution of the same primer with loss of adhesion, a result confirmed by infrared reflection analyses (ATR), which show that there is a detachment of the primer from the printing substrate as a cause of poor adhesion.

To confirm this hypothesis, when oriented polypropylene plastic film (OPP) is used as a printing substrate, there is a lower adhesion loss because the OPP has a better moisture barrier than PET and better protects the primer and the organic/inorganic fillers contained therein from moisture.

### SUMMARY OF THE INVENTION

The applicant has now found and it forms the object of the present invention a primer composition for digital inkjet printing on plastic polymer films, possibly laminated:
with one or more plastic films of the same or different polymer
with aluminium
and/or
with paper

comprising:
a) at least one resin having affinity with said plastic polymers;
b) at least one aliphatic or aromatic C2-C10 organic mono-, bi- or tricarboxylic acid, in which the aliphatic chain or aromatic ring can be replaced with one or more halogen atoms and having pKA between 0.2 and 5;
c) an organic solvent selected from: at least one ether, at least one ester, at least one alcohol, at least one ketone, at least one C6-C10 alkane, and mixtures thereof, said organic solvent having a boiling point between 35 and 250° C.

Another object is a digital inkjet printing process comprising the following steps:
i) the primer composition object of the present invention is deposited on the plastic film;
ii) removing the solvent by evaporation from the plastic film coming from step i)
iii) carrying out the digital inkjet printing of the plastic film from step ii).

### DETAILED DESCRIPTION OF THE INVENTION

For the purposes of the present invention, the definition “comprising” does not exclude the presence of additional components/steps not expressly mentioned after such a definition. On the contrary, the word constituted excludes the presence of such components/steps not expressly listed after such a definition.

For the purposes of the present invention, plastic films are intended preferably as those films based on polyethylene terephthalate, oriented polypropylene, cast polypropylene, coextruded with at least one layer of polypropylene, polyethylene, coextruded with at least one layer of polyethylene, mono-oriented polyethylene, bio-oriented polyamide polyethylene, mono- or bio-oriented polyamide, polyvinyl chloride (PVC), cellophane, polylactic acid (PLA), compostable films and in general plastic film which can be used to make a printed film.

For the purposes of the present invention, compostable films are intended as all those films which have acquired compostability certification in accordance with EN13432 and are listed and released by TUV, DINCERTCO and CIC (Italian composter consortium).

The resins or component a) of the primer composition are preferably selected from: polyurethane, polyester, acrylic, vinyl, ethyl vinyl, polyamide, ketone, aldehyde, polyvinyl butyral, epoxy resins.

The aliphatic, aromatic C2-C10 organic mono-, bi- or tricarboxylic acid, possibly replaced in the aliphatic chain or aromatic ring with one or more halogen atoms preferably chlorine or fluorine having pKA between 0.2 and 5 or component b) is preferably selected from: acetic acid, propionic acid, butyric acid, valeric acid, trichloroacetic acid, trifluoroacetic acid, chloroacetic acid, oxalic acid, malonic acid, succinic acid, glutaric acid, adipic acid, pimelic acid, sebacic acid, phthalic acid and aldaric acids, citric acid, isocitric acid, benzoic acid.

Aldaric acids (called glucaric acids in the past) are polyhydroxy bicarboxylic acids formally derived from an aldose by oxidation of both carbon atoms terminal to carboxyl groups, and among these, preferably, glucaric acid characterized by the following formula is used:

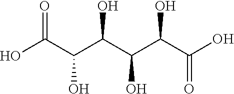 [SMILES: O=C(O)[C@@H](O)[C@@H](O)[C@H](O)[C@@H](O)C(=O)O]

The organic solvent is preferably selected from: ethyl acetate, ethyl propionate, methyl ethyl ketone, ethanol, n-butyl acetate, isobutyl acetate, hexane, or those belonging to the positive list defined by Swiss Ordinance 817.023.21 Annex 10, and mixtures thereof, more preferably it is ethyl acetate.

The resin or component a) of the composition object of the invention is preferably contained in concentrations between: 10 and 90%, more preferably 40 and 50% w/total w of the composition as prepared.

The mono-, bi- or tricarboxylic acid or component b) of the compositions object of the present invention are preferably contained in concentrations between: 1 and 10% w/w, more preferably between 2 and 5% w/total w of the composition as prepared.

When a white background is to be obtained, the primer composition object of the present invention comprises titanium dioxide and/or other substances capable of providing white colouration, such as for example precipitated calcium carbonate, precipitated barium sulphate, kaolin, silica, talc, Plastorit® (a mixture of mica, chlorite and quartz), mica, aluminium trioxide (ATH), Litopone (mixtures of zinc sulphide and barium sulphate), zinc oxide.

Thereby, colours can be overprinted, without having to apply a white ink which should react with the primer and act itself as primer for coloured inks.

Preferably the titanium dioxide and/or the white colouring substances are contained in amounts between 10 and 90% by weight, more preferably between 40 and 50%/by weight/total weight of the composition as prepared.

In the process of the invention the deposition of the primer composition preferably occurs by rotogravure application, but application with flexographic systems, inkjet systems, offset systems or spray systems are not excluded.

Preferably the process of the invention is carried out continuously, passing the plastic film on a conveyor belt, which brings the film first to an application zone of the primer composition according to step i), then to a zone where step ii) of removing the solvent with hot air is carried out, and then to a zone where step iii) of digital inkjet printing is carried out.

Hereinafter, for non-limiting illustrative purposes, examples of the primer composition according to the present invention and mechanical tests of primers according to the prior art and those of the primers according to the present invention are reported below.

### EXAMPLE 1

| COMPOSITION 1 | | |
|---|---|---|
| Component a) Vinyl/polyurethane resin | 40 | g |
| Component b) oxalic/succinic acid | 4 | g |
| Ethyl acetate as needed to | 100 | g |
| COMPOSITION 2 | | |
| Component a) Vinyl/polyurethane resin | 40 | g |
| Component b) oxalic/succinic acid | 3 | g |
| Ethyl acetate as needed to | 100 | g |
| COMPOSITION 3 | | |
| Component a) Vinyl/polyurethane resin | 40 | g |
| Component b) oxalic/succinic acid | 5 | g |
| Ethyl acetate as needed to | 100 | g |
| COMPOSITION 4 | | |
| Component a) Polyester resin/PVB | 50 | g |
| Component b) trichloroacetic acid | 4 | g |
| Ethyl acetate as needed to | 100 | g |
| COMPOSITION 5 | | |
| Component a) Polyester resin/PVB | 50 | g |
| Component b) trichloroacetic acid | 5 | g |
| Ethyl acetate as needed to | 100 | g |
| COMPOSITION 6 | | |
| Component a) Polyester resin/PVB | 50 | g |
| Component b) benzoic acid | 3 | g |
| Ethyl acetate as needed to | 100 | g |
| COMPOSITION 7 | | |
| Component a) polyester/acrylic resin | 35 | g |
| Component b) benzoic and succinic acid | 4 | g |
| Ethyl acetate as needed to | 100 | g |
| COMPOSITION 8 | | |
| Component a) polyester/acrylic resin | 35 | g |
| Component b) adipic and citric acid | 4 | g |
| Ethyl acetate as needed to | 100 | g |
| COMPOSITION 9 | | |
| Component a) polyester/acrylic resin | 35 | g |
| Component b) oxalic and adipic acid | 4 | g |
| Ethyl acetate as needed to | 100 | g |

### EXAMPLE 2

### Mechanical Tests With Known Primers and Primers Object of the Invention

A sample of 16 different products was then evaluated, evaluating the compatibility with cationic inorganic salts and assessing the essential physical chemical features for rotogravure applicability on plastic materials (coefficient of friction (COF), distension, abrasion resistance, transparency)

Of these, only the following showed compatibility with the salts
NOXENE AD 3307: polyurethane dispersion supplied by Novachem. Compatible with MgCl2 and CaCl2
NOXENE AD 3301: polyurethane dispersion supplied by Novachem. Compatible with MgCl2 and CaCl2
ESACOTE PUC1: polyurethane dispersion supplied by Lamberti. Compatible with MgCl2
DIGIPRIME 050: acrylic-polyurethane dispersion supplied by Michelmann. Compatible with CaCl2
ESACOTE PU 2001: polyurethane dispersion supplied by Lamberti. Compatible with MgCl2.
ESACOTE PR3FC: polyurethane dispersion supplied by LAMBERTI. Compatible with MgCl2.
GAF0119: polyurethane dispersion supplied by LAMBERTI. Compatible with the salts
POVAL 28-99: PVOH base dispersion supplied by KURARAY. Compatible with CaCl2,
PRIMER P7: vinyl acetate dispersion provided by SAKATA, (this is a composition already ready to be used).

In the next step, pieces of material coated with primer were prepared, using the above commercial compositions, and subsequently printed with reference inks using KYOCERA KJ4B printheads.

The printed material was combined with aluminium films using different polyurethane adhesives.

Both PET and OPP were used as printing media.

The adhesions of the laminates thus produced were controlled at a distance of 2, 3 and 7 days under controlled conditions (23° C. 30% RH) and also, after cross-linking, after conditioning at 30° C. and 80% RH for 1 day.

Adhesion tests were carried out in accordance with ASTM F904-98 “Standard Test Method for Comparison of Bond Strength or Ply Adhesion of Similar Laminates Made from Flexible Materials”.

The conditioning was carried out in climatic cells with control of the temperature and humidity variables.

The products which showed the best results are reported below:

TABLE 1
Adhesions on PET

| | | | | 30° C. - 80% |
|---|---|---|---|---|
| | 23° C. - 30% RH | | | RH |
| | 2 d - N/15 mm | 3 d - N/15 mm | 7 d - N/15 mm | 7 d - N/15 mm |
| NOXENE AD | 3.5 | 3.0 | 2.1 | 1.0* |
| 3307 | | | | |
| ESACOTE | 2.4 | 2.4 | 2.2 | 0.7* |
| PUC1 | | | | |
| DIGIPRIME | 4.1 | 3.4 | 1.8 | 0.7* |
| 050 | | | | |
| ESACOTE | 2.2 | 2.1 | 1.9 | 0.5* |
| PR3FC | | | | |
| POVAL 28-99 | 1.6 | 1.8 | 1.7 | 0.6* |
| PRIMER P7 | 0.8* | 0.4* | 0.6* | 0.6* |

*Primer detachment from the printing substrate

TABLE 2
Adhesions on OPP

| | | | | 30° C. - 80% |
|---|---|---|---|---|
| | 23° C. - 30% RH | | | RH |
| | 2 d - N/15 mm | 3 d - N/15 mm | 7 d - N/15 mm | 7 d - N/15 mm |
| NOXENE AD | 3.5 | 3.0 | 2.1 | 1.5* |
| 3307 | | | | |
| ESACOTE | 2.4 | 2.4 | 2.2 | 1.2* |
| PUC1 | | | | |
| DIGIPRIME | 4.1 | 3.4 | 1.8 | 1.2* |
| 050 | | | | |
| ESACOTE | 2.2 | 2.1 | 1.9 | 1.0* |
| PR3FC | | | | |
| POVAL 28-99 | 1.6 | 1.8 | 1.7 | 1.2* |
| PRIMER P7 | 4.0 | 3.5 | 3.4 | 3.0* |

*Primer detachment from the printing substrate

Industrial primer application tests were carried out on these products. In the case of ESACOTE PUC 1 and ESACOTE PR3FC, the test was blocked in the embryonic phase because a strain relief defect attributable to the chemistry of the products was observed during the industrial application in rotogravure which could not be resolved.

TABLE 3
Industrial adhesion tests on PET

| | | | | 30° C. - 80% |
|---|---|---|---|---|
| | 23° C. - 30% RH | | | RH |
| | 2 d - N/15 mm | 3 d - N/15 mm | 7 d - N/15 mm | 7 d - N/15 mm |
| NOXENE AD | 3.5 | 3.0 | 2.1 | 0.6* |
| 3307 | | | | |
| DIGIPRIME | 4.1 | 3.4 | 1.8 | 0.5* |
| 050 | | | | |
| POVAL 28-99 | 1.6 | 1.8 | 1.7 | 0.9* |
| PRIMER P7 | 0.8* | 0.4* | 0.6* | 0.6* |

*Primer detachment from the printing substrate

TABLE 4
Industrial adhesion tests on OPP

| | | | | 30° C. - 80% |
|---|---|---|---|---|
| | 23° C. - 30% RH | | | RH |
| | 2 d - N/15 mm | 3 d - N/15 mm | 7 d - N/15 mm | 7 d - N/15 mm |
| NOXENE AD | 2.8 | 2.6 | 2.7 | 2.5* |
| 3307 | | | | |
| DIGIPRIME | 2.5 | 2.8 | 3.1 | 2.2* |
| 050 | | | | |
| POVAL 28-99 | 1.8 | 2.2 | 2.0 | 0.8* |
| PRIMER P7 | 4.0 | 3.5 | 3.4 | 3.0 |

*Primer detachment from the printing substrate

The same tests were repeated on the innovative primer obtained with the composition I exemplified in example 1. The results are reported in the following tables.

TABLE 5
Adhesions on PET

| | | | | 30° C. - 80% |
|---|---|---|---|---|
| | 23° C. - 30% RH | | | RH |
| | 2 d - N/15 mm | 3 d - N/15 mm | 7 d - N/15 mm | 7 d - N/15 mm |
| INNOVATIVE | 3.8 | 4.2 | MB | MB |
| PRIMER | | | | |

MB material breakage

TABLE 6
Adhesions on OPP

| | | | | 30° C. - 80% |
|---|---|---|---|---|
| | 23° C. - 30% RH | | | RH |
| | 2 d - N/15 mm | 3 d - N/15 mm | 7 d - N/15 mm | 7 d - N/15 mm |
| INNOVATIVE | 2.4 | 3.5 | MB | MB |
| PRIMER | | | | |

MB material breakage
The industrial tests also confirmed the results obtained at the laboratory scale.

TABLE 7
Industrial Adhesion tests on PET

| | | | | 30° C. - 80% |
|---|---|---|---|---|
| | 23° C. - 30% RH | | | RH |
| | 2 d - N/15 mm | 3 d - N/15 mm | 7 d - N/15 mm | 7 d - N/15 mm |
| INNOVATIVE | 4.2 | 4.8 | 4.1 | 3.8 |
| PRIMER | | | | |

TABLE 8
Industrial Adhesion tests on OPP

| | | | | 30° C. - 80% |
|---|---|---|---|---|
| | 23° C. - 30% RH | | | RH |
| | 2 d - N/15 mm | 3 d - N/15 mm | 7 d - N/15 mm | 7 d - N/15 mm |
| INNOVATIVE | 3.5 | 3.9 | 3.0 | 3.4 |
| PRIMER | | | | |

1. A primer composition for digital inkjet printing on a plastic polymer film
comprising:
a) at least one resin having affinity with the plastic polymer of said film;
b) at least one aliphatic or aromatic C2-C10 organic mono-, bi- or tricarboxylic acid, possibly being replaced in the aliphatic chain or aromatic ring with one or more halogen atoms and having pKA between 0.2 and 5;
c) a solvent, wherein said solvent consists of:
one or more organic solvents selected from at least one ether, at least one ester, at least one aliphatic alcohol, at least one ketone, at least one C6-C10 alkane, and mixtures thereof, said organic solvents having a boiling point between 35 and 250° C.

2. The primer composition according to claim 1, wherein the plastic polymer films are selected from polyethylene terephthalate, oriented polypropylene, cast polypropylene, coextruded with at least one layer of polypropylene, polyethylene, coextruded with at least one layer of polyethylene, mono- or bi-oriented polyethylene, polyamide, mono- or bio-oriented polyamide, polyvinyl chloride, cellophane, polylactic acid, compostable films, and in general plastic film which can be used to make a printed film.

3. The primer composition according to claim 1, wherein said resins having affinity for plastic polymers are selected from polyurethane, polyester, acrylic, vinyl, ethyl vinyl, polyamide, ketone, aldehyde, polyvinyl butyral and epoxy resins.

4. The primer composition according to claim 1, wherein said at least one acid is selected from: acetic acid, propionic acid, butyric acid, valeric acid, trichloroacetic acid, trifluoroacetic acid, chloroacetic acid, oxalic acid, malonic acid, succinic acid, glutaric acid, adipic acid, pimelic acid, sebacic acid, phthalic acid, benzoic acid, aldaric acids, citric acid, isocitric acid.

5. The primer composition according to claim 1, wherein the organic solvent is selected from ethyl acetate, ethyl propionate, methyl ethyl ketone, ethanol, n-butyl acetate, isobutyl acetate, hexane or those belonging to the positive list defined by Swiss Ordinance 817.023.21 Annex 10 and/or mixtures thereof.

6. The primer composition according to claim 1, wherein the solvent is ethyl acetate.

7. The primer according to claim 1, wherein the resin a) is contained at concentrations between: 10 and 90% w/total w of the composition as prepared.

8. The primer according to claim 1, wherein at least one mono-, bi- or tricarboxylic organic acid is contained in total amounts between 1 and 10% w/total w of the composition as prepared.

9. The primer according to claim 1, comprising titanium dioxide and/or substances capable of imparting white colouration.

10. The primer according to claim 9, wherein the titanium dioxide and all the substances providing white colouration are contained in concentrations between 10 and 90% by weight on the total weight of the composition as prepared.

11. A digital inkjet printing process comprising the following steps:
i) depositing the primer composition according to claim 1 on the plastic film,
ii) removing the solvent by evaporation from the plastic film coming from step i)
iii) carrying out the digital inkjet printing of the plastic film from step ii).

12. The process according to claim 11, wherein the process is carried out continuously, passing the plastic film on a conveyor belt, which brings the film to a zone where step i) of applying the primer composition is carried out, subsequently to a zone where step ii) of removing the solvent with hot air is carried out and subsequently to a zone where step iii) of digital inkjet printing the film is carried out.

13. The primer composition according to claim 1, wherein the plastic polymer film is laminated with
one or more plastic films of the same or different polymer;
aluminum; and/or
paper.
